(19) United States
(12) Patent Application Publication
(10) Pub. No.: US 2005/0188395 A1
(43) Pub. Date: Aug. 25, 2005

(54) Dual-use audio signal player for analogue record and digital CD

(76) Inventor: Chiu-Hsiung Liu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/784,293

(22) Filed: Feb. 24, 2004

(51) Int. Cl. G11B 19/20; G11B 17/03

(52) U.S. Cl. 720/696

(57) ABSTRACT

A dual-use audio signal player includes a CD playing mechanism, a direct driver mechanism, a special disk capable of being manually angularly displaced relative to the direct driver mechanism, and a sensor mechanism electrically connected to the CD playing mechanism and capable of detecting the way the special disk is moved; the special disk is to be operated for simulating a vinyl analogue record being manually moved while the record is being played; when the special disk is operated with a person's hand, the CD playing mechanism will process music data in accordance with movement of the special disk as detected by the sensor mechanism, and special effects will be produced while the music is being played through the CD playing mechanism.

### BACKGROUND OF THE INVENTION

1. Field of the Invention

The present invention relates to a dual-use audio signal player, which includes a CD playing mechanism, and a special disk capable of being manually operated for simulating a vinyl analogue record being manually moved while the record is being played; thus, when the special disk is operated with hands, the CD playing mechanism will, before sending out music, process music data in accordance with movement of the special disk, and special effects will be produced on the music; the present player further has a stylus-equipped tone arm such that a vinyl analogue record can be played when the record is used instead of the special disk.

2. Brief Description of the Prior Art

In order to help increase hot and exciting atmosphere in a concert or a party such as is held in a PUB or a dancing hall, the DJ usually makes the music played with special effects by means of moving the analogue vinyl record positioned on the turntable manually at changing speeds and in alternate directions. When the DJ stops moving the record with his hands, the record will be played on the record player in the normal way immediately.

However, a single analogue vinyl record has very limited capacity to store music with. Consequently, the DJ has to prepare a lot of analogue records in every event, and the records are likely to cause the DJ inconvenience due to the large size and heavy weight. And, it is difficult for a DJ to exactly find the starting point of the grooves for a particular song on a record immediately when he wants to change to that song.

Therefore, various forms of auxiliary devices are developed for use together with digital audio signal players, e.g. CD players, MP3 players, which auxiliary devices can be manually operated for simulating an analogue vinyl record being manually moved while the analogue record is being played, such that special effects are produced while music is being played through the digital audio signal players. However, because such auxiliary devices are not equipped with direct driver motors, there is still a significant difference between the feeling in operating the auxiliary devices and that in operating an analogue record.

### SUMMARY OF THE INVENTION

It is a main object of the present invention to provide a dual-use audio signal player to overcome the above disadvantages.

The dual-use audio signal player, which includes a CD playing mechanism, a direct driver mechanism, a special disk capable of being manually angularly displaced relative to the direct driver mechanism, and a sensor mechanism electrically connected to the CD playing mechanism and capable of detecting the way the special disk is moved, which special disk is to be operated for simulating a vinyl analogue record being manually moved while the record is being played; thus, when the special disk is operated with hands, the CD playing mechanism will, before sending out music, process music data in accordance with movement of the special disk as detected by the sensor mechanism, and special effects will be produced on the music; the present player further has a stylus-equipped tone arm such that a vinyl analogue record can be played when the record is positioned on a turntable of the direct driver mechanism instead of the special disk.

### BRIEF DESCRIPTION OF THE DRAWINGS

The present invention will be better understood by referring to the accompanying drawings, wherein:

FIG. 1 is a perspective view of the dual-use audio signal player in the present invention,

FIG. 2 is a circuit block diagram of the present audio signal player,

FIG. 3 is an exploded perspective view of the direct driver motor of the dual-use audio signal player according to the present invention,

FIG. 4 is a vertical section of the direct driver motor,

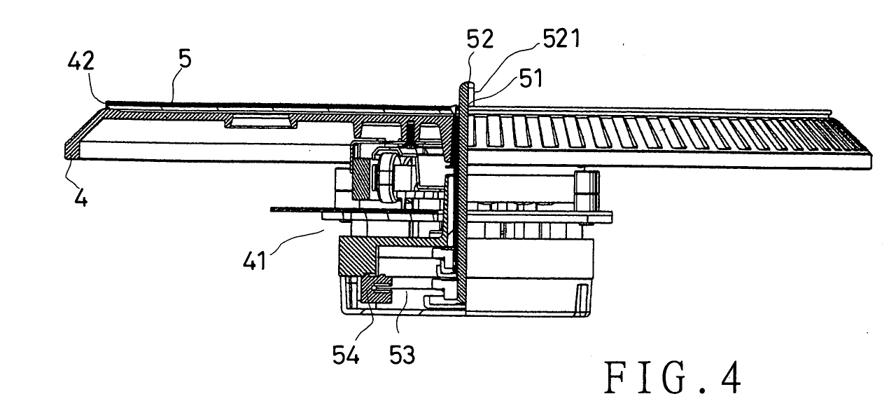

FIG. 5 is a top view of the disk especially made for the dual-use audio signal player of the present invention, and

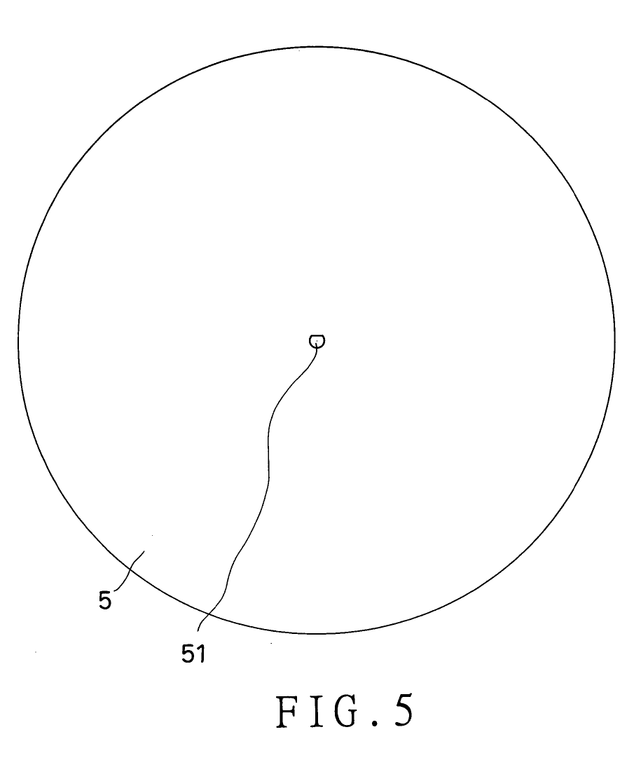

FIG. 6 is a perspective view of the rotary shaft of the sensor mechanism in the present invention.

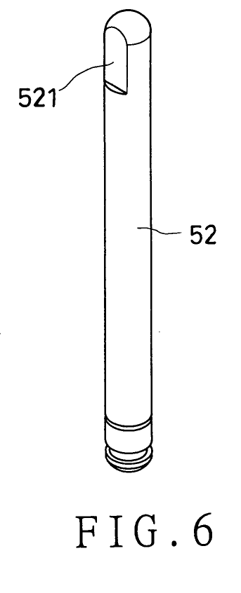

### DETAILED DESCRIPTION OF THE PREFERRED EMBODIMENTS

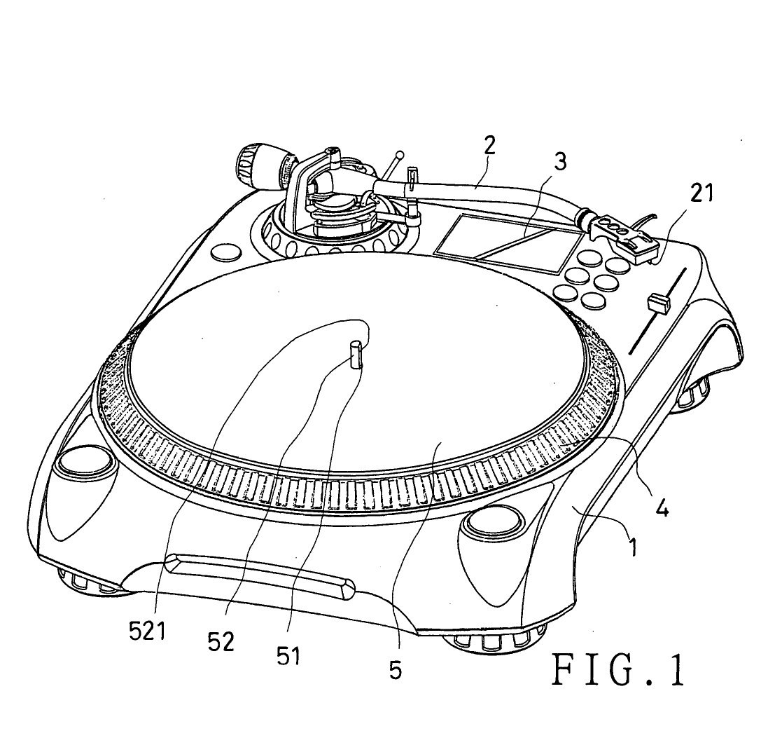

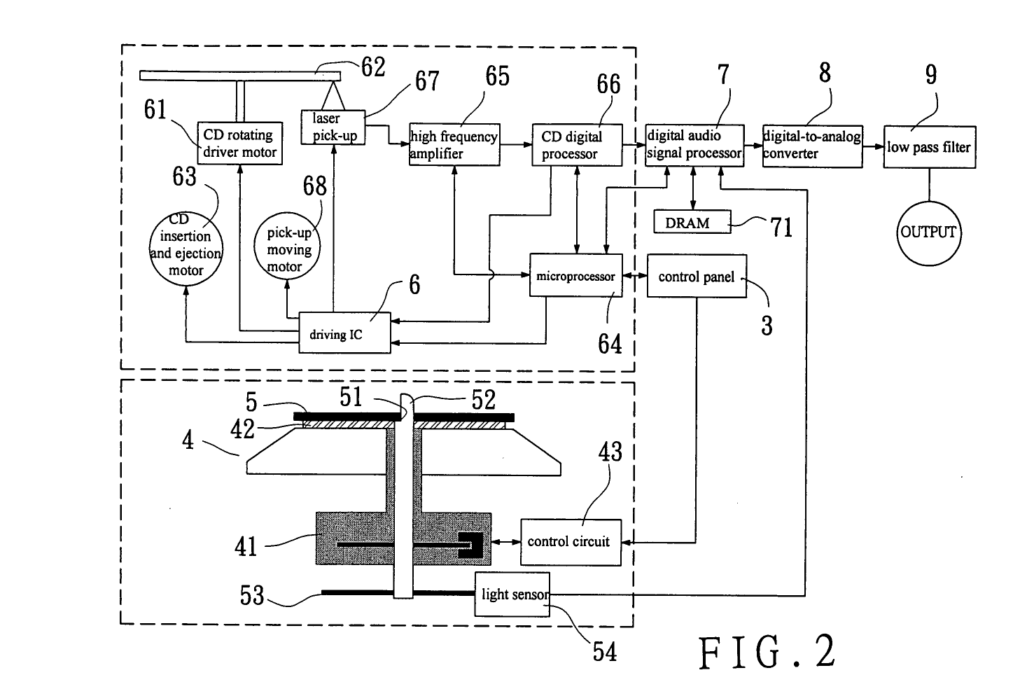

Referring to FIGS. 1 and 2, a preferred embodiment of a dual-use audio signal player in the present invention includes a housing 1, a CD playing mechanism held in the housing 1, a direct driver mechanism for actuating a special disk 5 with, and a sensor mechanism for detecting movement of the special disk 5, which special disk 5 can be operated to produce special effects on music that is being played through the present audio signal player.

The CD playing mechanism includes a driving IC 6, a CD rotating driver motor 61, a CD support table 62, a CD insertion and ejection motor 63, a microprocessor 64, a high frequency amplifier 65, a CD digital processor 66, a laser pick-up 67, a pick-up moving motor 68, a digital audio signal processor 7, a dynamic random access memory (DRAM) 71, a digital-to-analog converter 8, and a low pass filter 9.

The CD support table 62 is provided for a CD to be positioned thereon, and connected to the CD rotating driver motor 61. The driving IC 6 is electrically connected to the rotating driver motor 61, the CD insertion and ejection motor 63, and the pick-up moving motor 68 for controlling the same with; the CD rotating driver motor 61 is provided for turning the CD support table 62 with; the CD insertion and ejection motor 63 is provided for move a CD onto and away from the CD support table 62. The pick-up moving motor 68 is provided for moving the laser pick-up 67 with.

When the microprocessor 64 is activated, it will make the high frequency amplifier 65 open laser light, and the laser pick-up 67 activated through both the CD digital processor 66 and the driving IC 6. The laser pick-up 67 will send a signal to the CD digital processor 66 via the high frequency amplifier 65 while the CD digital processor 66 will notify the microprocessor 64 whether focusing action is successful or not; in case the focusing action fails, all actions will stop; in case the focusing action is successful, the microprocessor 64 will control the CD digital processor 66 such that the driving IC 6 is made to activate the CD rotating driver motor 61, and the CD positioned on the CD support table 62 is turned at twice normal speed. Thus, the laser pick-up 67 will read music data and time-related information in the CD, and send the data to the microprocessor 64 as well as the digital audio signal processor 7 via both the high frequency amplifier 65 and the CD digital processor 66. Then, the microprocessor 64 will make the time-related information of the CD displayed on the control panel 3. And, the digital audio signal processor 7 will transfer the music data of the CD to the dynamic random access memory 71. Thus, digital music data in the DRAM 71 can be transferred to the digital-to-analog converter 8 to become analogue ones, and sent out through the low pass filter 9 to become music when the CD playing mechanism is in operation.

Furthermore, a control panel 3 is provided on the housing 1 for controlling the present dual-use audio signal player with. And, a tone arm 2, which has a stylus 21 fitted thereto, is fitted to the housing 1.

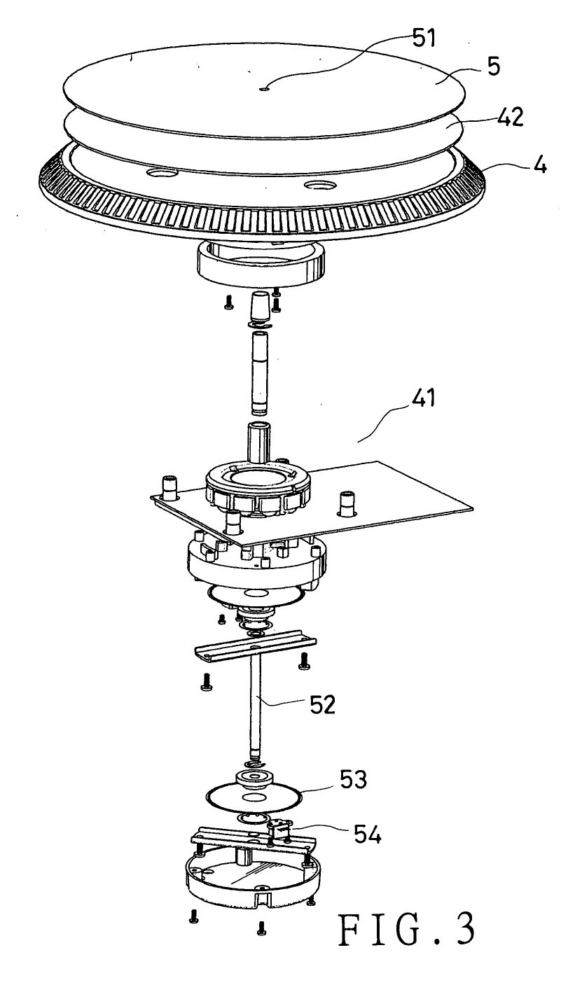

Referring to FIGS. 2 and 3, the direct driver mechanism includes a turntable 4 arranged on top of the housing 1, a direct driver motor 41 held in the housing 1, and a control circuit 43 electrically connected to the direct driver motor 41 for actuating and stopping the direct driver motor 41 as well as for controlling speed and direction of rotation of the direct driver motor 41. The direct driver motor 41 has a large torque constant. The turntable 4 has a round support plate 42 thereon, and the turntable 4 and the round support plate 42 are securely connected to an upper end of an output shaft of the direct driver motor 41. The special disk 5 has an engaging hole 51 on the center thereof, and is positioned on the round support plate 42 to be used.

Referring to FIGS. 2 and 3 again, the sensor mechanism includes a rotary shaft 52, a co-moving plate 53 securely joined to a lower end of the rotary shaft 52, and a light sensor 54 arranged under and opposing the co-moving plate 53. The rotary shaft 52 is passed through and angularly displaceable relative to the output shaft of the direct driver motor 41. The rotary shaft 52 is passed through the round support plate 42 at an upper end, and has an engaging portion 521 at the upper end for connection with the engaging hole 51 of the special disk 5; when the special disk 5 is fitted around the engaging portion 521 of the shaft 52 at the engaging hole 51, the special disk 5 and the rotary shat 52 will always turn together with each other. The round support plate 42, the special disk 5, and the rotary shaft 52 will normally rotate at the same speed and in the same direction, when the direct driver motor 41 operates to rotate the round support plate 42. And, the special disk 5 will cause the rotary shaft 52 to move in the way as it when it is angularly displaced relative to the round support plate 42 by a DJ's hand. Consequently, the co-moving plate 53 is angularly displaced in the same way as the special disk 5.

The light sensor 54 can detect movement of the co-moving plate 53, and is electrically connected to the digital audio signal processor 7 of the CD playing mechanism. Therefore, in case the special disk 5 is manually operated to turn at various speeds and alternate directions while the CD playing mechanism is playing music as well as while the direct driver motor 41 is operating to rotate the turntable 4, the digital audio signal processor 7 will process digital music data in the DRAM 71 in accordance with the movement of the co-moving plate 53 as detected by the light sensor 54, which processed digital music data are then transferred to the digital-to-analog converter 8 to become analogue ones, and sent out through the low pass filter 9 to become music. And, special effects are produced on the music accordingly.

In addition, a conventional analogue vinyl record is positioned on the support plate 42 and fitted to the rotary shaft 52 instead of the special disk 5, and the stylus 21 of the tone arm 2 is used on the analogue vinyl record to play the record.

From the above description, it can be easily understood that the present dual-use audio signal player has advantages as followings:

1. The present player allows a DJ to feel like he is operating a conventional analogue vinyl record to produce special effects while operating the special disk 5, and allows the DJ to use compact disks instead of conventional analogue vinyl records as the storage of music, saving him much trouble. In other words, the present player has advantages of compact disks and conventional analogue records.

2. The present player can also be used to play conventional analogue records with the help of the engaging portion 521 of the rotary shaft 52, the direct driver motor 41, the turntable 4, and the stylus 21.

1. A dual-use audio signal player, comprising
a CD playing mechanism, including:
(1) a laser pick-up for reading music and audio data in a CD;
(2) a DRAM for storing digital music data therein;
(3) a digital audio signal player for processing digital music data stored in the DRAM with; and
(4) a digital-to-analog converter electrically connected to the digital audio signal player for changing the digital music data into analogue ones such that the data can be played;
a direct driver motor with large torque; the motor being controlled in respect of start, stoppage, and rotational direction and speed thereof by means of a control circuit;
a turntable securely connected to an output shaft of the direct driver motor; the turntable having a round support plate secured thereon;
a rotary shaft passed through and angularly displaceable relative to the output shaft of the direct driver motor; the rotary shaft being passed through the round support plate at an upper end thereof; the rotary shaft having an engaging portion at the upper end;
a special disk positioned on the round support plate such that the round support plate can make the special disk angularly displaced together with it when the motor operates to rotate the turntable, and such that the special disk can be angularly displaced relative to the round support plate by a person's hand; the special disk being fitted around the engaging portion of the rotary shaft at an engaging hole thereof such that the rotary shaft will move together with the special disk when the special disk is angularly displaced relative to the round support plate by a person's hand;
a co-moving plate securely connected to the rotary shaft;
a light sensor disposed opposite to the co-moving plate for detecting movement of the co-moving plate with; the light sensor being electrically connected to the digital audio signal player; while the digital music data in the DRAM is being sent to the digital-to-analog converter and played, the digital audio signal processor being capable of processing the digital music data in accordance with movement of the co-moving plate as detected by the light sensor in case the special disk is manually operated to turn at various speeds and alternate directions, thus making special effects on music that is being played by the CD playing mechanism; and
a tone arm next the turntable; the tone arm having a stylus fitted thereon for playing a vinyl analogue record with when the vinyl analogue record is positioned on the round support plate instead of the special disk as well as fitted around the rotary shaft.
